(19) United States
(12) Patent Application Publication
(10) Pub. No.: US 2007/0150966 A1
(43) Pub. Date: Jun. 28, 2007

(54) Method and apparatus for maintaining a secure software boundary

(76) Inventors: Wesley A. Kirschner, Farmington, CT (US); Gary S. Jacobson, Norwalk, CT (US); John A. Hurd, Torrington, CT (US); G. Thomas Athens, Rotonda West, FL (US); Walter J. Baker, Stratford, CT (US); Ramprasad Bagawadi-Ellur, Naugatuck, CT (US); Sathish Varma Kalidindi, Shelton, CT (US); Steven J. Pauly, New Milford, CT (US)

Correspondence Address: George M. Macdonald, Pitney Bowes Inc.;Intellectual Property and Technology Law Dept., 35 Waterview Drive, P.O. Box 3000, Shelton, CT, 06484, US

(21) Appl. No.: 11/317,996

(22) Filed: Dec. 22, 2005

(51) Int. Cl. G06F 17/30

(52) U.S. Cl. 726/30

(57) ABSTRACT

In accordance with an exemplary embodiment of the invention, a method includes storing at least one data element in an external memory located outside of a security boundary, and executing a validation algorithm within the security boundary to repeatedly validate the at least one data element. The validation algorithm includes validating a size of the at least one data element, validating a hash of the at least one data element, and validating a signature of a hash file comprising information corresponding to the at least one data element.

### BACKGROUND OF THE INVENTION

1. Field of the Invention

The present invention relates generally to a method for securing and validating data elements stored in memory external to a processor.

2. Background Information

Microprocessors operating in a secure environment often times require the partitioning of software and other data between a memory and one or more processors in a manner which provides security for the software and data. By “secure environment”, it is meant any environment wherein software or other data are utilized and to which access is limited or otherwise restricted.

One method employed to provide secure access to software and data involves storing the software and data in the internal memory of a processor. As used herein, “internal memory” refers to a digital storage medium for storing data capable of communication with a processor without the need of an external bus or other communication link external to the processor. Examples of such internal memory include, but are not limited to, internal flash memory and internal random access memory (RAM). As such, a security boundary is formed between the internal memory and any other external memory upon which may be stored data and software for access. By storing sensitive data in the internal memory, the possibility of outside tampering with the data is reduced. Specifically, data stored in internal memory cannot be directly queried by an external entity.

As it is not always preferable to store all software and data to be utilized within the internal memory of a processor, methods have been devised to enable the application of enhanced security to the access and use of software and data stored external to a processor. Examples of such methods include utilizing the processor on which externally obtained software is to be processed to verify and validate the origin of the external software. Specifically, if a request, such as a function invocation, is received by a processor from an outside entity from beyond the aforementioned security boundary, the processor can proceed to validate the origin of the request. As an example, the processor can examine the stack to determine the return address to which control is to be passed after performing the requested functionality. If the return address is determined to reside outside of the memory addresses occupied by valid calling entities, as might occur when an actor of nefarious intent attempts to access the processor, performance of the requested functionality can be halted.

While such validation methods are useful for adding a level of security to the execution of software received from or requested by an external source, they do not operate to secure the data and software residing external to the processor

### SUMMARY OF THE INVENTION

In accordance with an exemplary embodiment of the invention, a method includes storing at least one data element in an external memory located outside of a security boundary, and executing a validation algorithm within the security boundary to repeatedly validate the at least one data element. The validation algorithm includes validating a size of the at least one data element, validating a hash of the at least one data element, and validating a signature of a hash file comprising information corresponding to the at least one data element.

In accordance with another exemplary embodiment of the invention, an apparatus includes a processor coupled to an internal memory the processor and the internal memory residing within a security boundary, at least one data element stored on an external memory residing outside the security boundary accessible to the processor, a validation algorithm stored in the internal memory for execution by the processor to repeatedly validate the at least one data element.

### BRIEF DESCRIPTION OF THE DRAWINGS

The foregoing aspects and other features of the present invention are explained in the following description, taken in connection with the accompanying drawings, wherein:

FIG. 1 is a diagram of an exemplary embodiment of a hardware configuration for practicing the invention.

FIG. 2 is a diagram of an exemplary embodiment og a hash file of the invention.

FIG. 3 is a flow chart of an exemplary embodiment of a method of the invention.

FIG. 4 is a diagram of an exemplary embodiment of an apparatus for practicing the invention.

### DETAILED DESCRIPTION

In exemplary embodiments of the invention, a method is provided for securing software and data located outside of a security boundary of a processor. One or more validation algorithms, formed of machine readable code, are executed in or from the internal flash and internal random access memory (RAM) of a processor to validate data elements, formed of software and other data, stored in external memory beyond the security boundary. In this manner, externally stored data elements are validated independent of their location. By “validation” it is meant that the data elements are examined to determine the presence of an unwanted or unauthorized alteration to a data element.

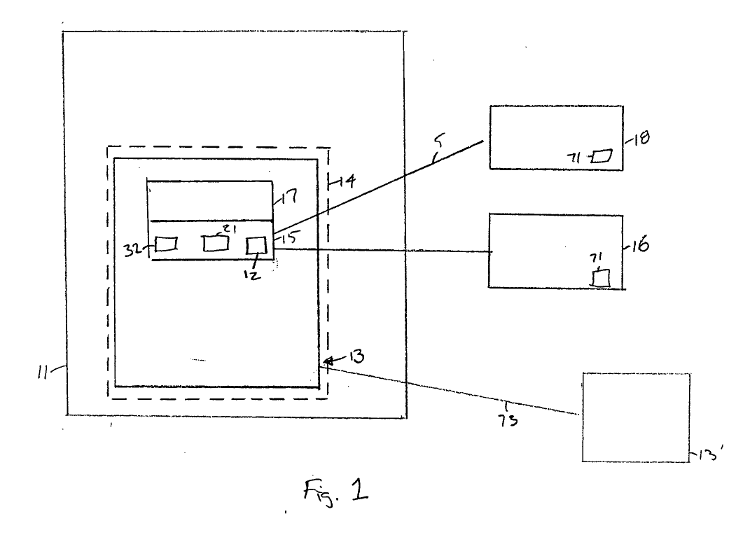

With reference to FIG. 1, there is illustrated an exemplary embodiment of a hardware configuration for practicing the invention. A microprocessor 11 includes a secure processor 13. The secure processor 13, or processor 13, is any digital computation device including, but not limited to, a central processing unit (CPU). Processor 13 can comprise a component of a postage security device (PSD). Fabricated as part of processor 13, or coupled to processor 13 without the need for an external bus, is internal memory formed of internal flash 15 and internal RAM 17. In an exemplary embodiment, the operating system (OS), providing the instructions for the operation of the processor 13, is stored on internal RAM 17. As illustrated, a security boundary 14 corresponds to the physical extent of the processor 13 and internal memory 15, 17. As used herein, the “security boundary” is defined as referring to the physical extent of a processor 13 and the internal memory 15, 17 coupled thereto. Within the security boundary 14, data can be transferred between the processor 13 and the internal memory 15, 17 in a tamper proof manner. This tamper proof attribute arises from the property that the internal flash 15 and internal RAM 17 can only be accessed directly by the processor 13. In an exemplary embodiment, cryptographic keys, including, but not limited to, public and private keys, are stored in the internal flash 15 and utilized by the processor 13 to validate signatures on externally stored elements.

External to the processor 13 and security boundary 14 is external memory 16, 18. In an exemplary embodiment, external memory is formed of external RAM 18 and external flash memory 16. While illustrated as residing outside of the processor 13 and microprocessor 11, external memory 16, 18 can reside within microprocessor 11 but outside of security boundary 14. External memory 16, 18 is coupled to processor 13 via a coupling 5, such as that provided by an external data bus. Any number of external RAM 18 and external flash memory 16 can be coupled to the processor 13.

As noted above, a plurality of validation algorithms 12 are stored in internal memory 15, 17, preferably in internal flash memory 15, for providing validation of data elements 71 stored in external memory 16, 18. In an exemplary embodiment, the validation algorithms 12 are designated to be executed and run by the processor 13 as background tasks when the processor 13 is otherwise idle. Specifically, the validation algorithms 12 are long running executables that are executed with a priority that is sufficiently low so as to not interfere with the execution by the processor 13 of higher priority tasks. As described more fully below, when executed as a long running task or executable, one of the validation algorithms 12 can continually and repeatedly operate to validate data elements 71 stored in external memory 16, 18.

Conversely, in one exemplary embodiment, one or more of the validation algorithms 12 can be executed periodically as the highest priority tasks by the processor 13. In such an instance, the validation algorithms 12 are not executed to be long running. By periodically and repeatedly invoking the validation algorithms at the highest priority, it is made more difficult to prevent the validation algorithms 12 from running, for example, as when an external source of software attempts to be executed by the processor 13 at a high priority. The validation algorithms 12 are preferably executed at a power up of a processor 13 for executing said validation algorithms 12.

Whether long running at a relatively low priority, or running periodically at a high priority, one or more of the validation algorithms 12 can operate to continually check data elements 71 stored in the external RAM 18 and external flash memory 16. As described more fully below, the validation algorithms 12 operate to validate the integrity of the data elements 71 stored in the external RAM 18 and external flash memory 16 and to report instances wherein a discrepancy is found. In response to such a report, the processor 13 can halt processing or take other actions consistent with preserving the integrity of ongoing operations. As a result, a single, long running validation algorithm 12 can execute as a background task that serves to continually validate data elements without the need to invoke validation in response to defined event.

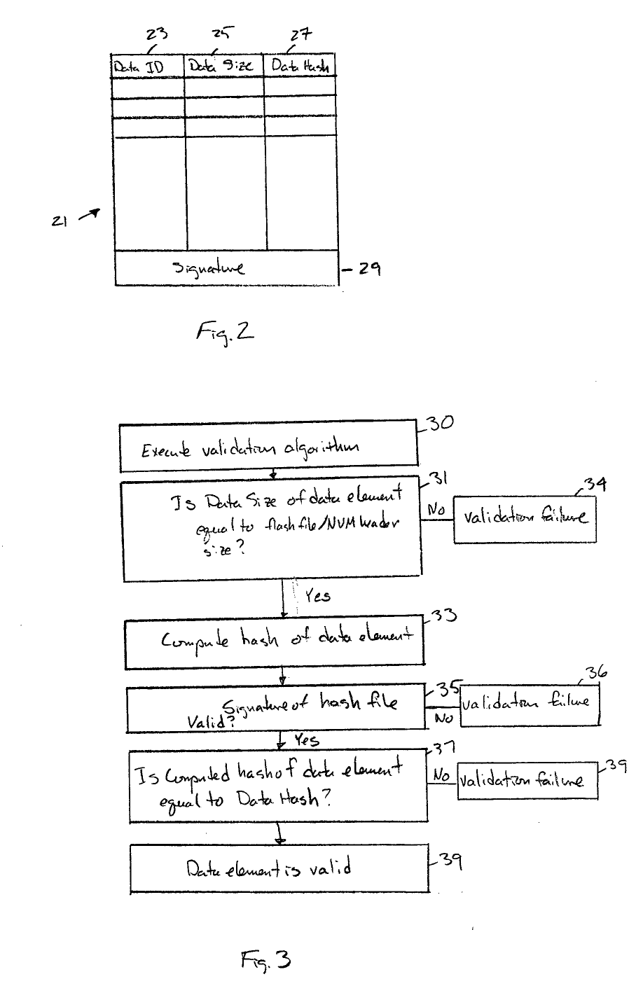

With reference to FIG. 2, there is illustrated an exemplary embodiment of a hash file 21 utilized by one or more validation algorithms 12 to perform external data element 71 validation. While illustrated in tabular form, hash file 21 can be any format, such as a flat file, capable of representing a plurality of attributes for each data element 71 to be validated and including a verifiable signature. As illustrated, a plurality of rows are provided for storing data descriptive of data elements 71 to be validated. In the exemplary embodiment shown, the hash file 21 includes three columns corresponding to data element attributes Data ID 23, Data Size 25, and Data Hash 27. In addition, a signature 29 is associated with the hash file 21. Data ID 23 is an identifier, such as a numeric or alphanumeric designation, that uniquely identifies a data element 71 to be validated. In one exemplary embodiment, the Data ID 23 can include both the location and name of a data element 71. In an alternative exemplary embodiment described more fully below, a look-up table 32 is maintained to map the Data ID 23 of a data element 71 to the data element's 71 location.

The Data Size 25 column attribute holds a value corresponding to the size of the data element 71. Such a size can be expressed, for example, in units of bytes. Data Hash 27 contains a value corresponding to a hash computed for the related data element 71. A single hash file 21 can include a plurality of rows corresponding to a plurality of data elements 71. As noted, a signature 29 is applied to the hash file 21. Signature 29 incorporates a secret key, required for signature verification, accessible to the processor 13 and preferably stored in internal flash 15.

As noted above, the Data ID can include information describing the name and location of the associated data element 71. In an alternative exemplary embodiment, a look-up table 32 is utilized to map each Data ID to the file name/location of a data element 71 protected by the hash file. In a preferred embodiment, the look-up table 32 is stored in the internal flash 15 so that it cannot be changed or tampered with by an external agent. The look-up table 32 includes, at least, one or more Data IDs respectively associated with a file name/location of the data element 71 corresponding to the Data ID.

An exemplary embodiment of a method for updating a hash file 21 is as follows. Maintenance of the hash file 21 is preferably performed by the processor 13 while the resulting hash file 21 is stored in internal flash memory 15. When a data element 71 is added to external memory 16, 18 that is to be validated via a hash, the hash file 21 is updated with a new record (corresponding to a row of hash file 21). As noted above, each record includes a Data ID 23 of the data element 71, a Data Size 25 of the element, and a Data Hash 27 computed by applying a hash to the data element 71 to be added. After completing the addition or updating of a record or records corresponding to a data element 71 or data elements 71 to hash file 21, a signature is recomputed for the hash file 21 and is appended to, or otherwise added to, the hash file 21. Although the incorporation of the signature to the hash file 21 allows for the hash file 21 to be stored in external memory 16, 18, it is preferred to store the hash file 21 in internal flash memory 15.

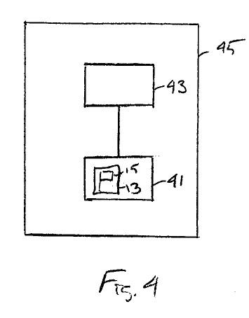

With reference to FIG. 3, there is illustrated an exemplary method for utilizing a hash file 21 to validate one or more data elements 71 stored in external memory 16, 18. At block 30, a validation algorithm 12 is executed to validate a data element 71. At block 31, a Data Size 25 of a data element 71 to be validated is compared to the size of the data element 71 indicated in the flash file/non-volatile memory (NVM) header. The flash file/NVM header is maintained by the operating system and maintains a record of the size of each data element 71 as stored on a memory device. The size retrieved from the flash file/NVM header is compared to the Data Size 25 retrieved from hash file 21 at block 31. If the two sizes do not match, a validation failure is indicated at block 34 and further processing of the data element 71 is halted. If the two sizes are in correspondence, processing proceeds to block 33. At block 33, a hash of the data element 71 to be verified is computed starting at the beginning of the data element 71 and proceeding for a number of bytes equal to the size of the data element 71 indicated by the retrieved Data Size 25.

Next, at block 35 the signature 29 of the hash file 21 is verified using a secure key stored in internal flash 15. If the signature 29 indicates that the hash file 21 has been tampered with, a validation failure is indicated at block 36 and further processing of the data element 71 is halted. If the signature 29 is verified to be valid, processing continues to block 37 where the computed hash of the data element 71 from block 33 is compared to the Data Hash 27 of the data element 71 stored in the hash file 21. If the two hash values are in correspondence, the data element 71 is determined to be valid at block 39. If the two hash values are not equivalent, a validation failure is indicated at block 38 and further processing of the data element 71 is halted.

While illustrated with a single signature 29 corresponding to an entire hash file 21, the invention is not so limited. In an alternative embodiment, a signature 29 can be associated with each record, or row, of the hash file 21. As noted above, each validation algorithm 12 executed to perform the validation method described above can be assigned an individual task priority to control the amount of time the processor 13 devotes to executing the validation algorithm 12. In operation, more than one validation algorithm 12 can be executed simultaneously with differing priorities assigned to each instance of a validation algorithm 12.

As a result, different validation algorithms can access different hash files 21 resulting in different data elements 71 being validated at different frequencies. In addition, for any one hash file 21, the data elements 71 defined in the hash file 21 can be additionally assigned a priority attribute. When a validation algorithm 12 utilizes the hash file 21 to perform validation, the priority attribute can be utilized to control the frequency at which the data element 71 is validated. In an alternative exemplary embodiment, a random number generator can be utilized to randomly select data elements 71 specified in a hash file 21 and to perform validation on the selected data element 71. Further note that use of the hash file 21 particularly defines the data elements 71 resident on external flash memory 16 and external RAM 18 to be validated. As a result, it is possible to partition the external memory 16, 18 into secure portions, containing data elements 71 to be validated, and non-secure portions, containing data elements 71 requiring no validation.

While illustrated as operating with a single external flash memory 16 and external RAM, the invention is not limited to the number of external memories upon which data elements 71 are stored. With continued reference to FIG. 1, there is illustrated an exemplary configuration wherein a processor 13′ is coupled to the processor 13 performing the data element 71 validation. Processor 13′ and processor 13 are coupled via communication link 73 such as, for example, an external bus. In such a configuration, validation of data elements 71 can be performed by validation algorithms 12 running on processor 13 with the results of the validation being communicated to processor 13′. Preferably, such validation results are tagged with a secure signature by processor 13, the signature being authenticated by processor 13′ upon reception.

With reference to FIG. 4, there is illustrated an exemplary embodiment of the invention wherein the processor 13 and its internal memory 15 form part of a postage security device 41. Postage security device is coupled to a postage printer 43 for printing postage. Together, postage security device 41 and postage printer 43 form parts of a postage meter 45.

In addition to authenticating data elements 71 stored in external memory devices 16, 18, the validation algorithms 12 can compute and store a signature associated with all or part of the memory comprising internal flash memory 15 as well as internal RAM 17. As a result, there is illustrated in the exemplary embodiments described above, a method for securing parts of non-secure memories and devices using a single processor 13. By executing the validation algorithms 12 as a long running, background task, there is provided the capability of performing validation utilizing a power up execution, constant background tasking, OS time slicing, OS task prioritization, and random data element checking. In addition to the validation algorithms described above, any other security techniques and algorithms, such as those incorporating blinding techniques, may be incorporated and employed with the validation algorithms 12.

The invention is not limited to any one form of digital security when computing and decoding hashes and signatures as described above. Rather, the invention is drawn broadly to encompass any and all forms of security including, but not limited to, digital signal algorithm (DSA), and elliptical curve digital signal algorithm (ECDSA). In addition, the invention places no limitations on the protocols employed to load data elements 71 into the external flash memory 16 and external RAM 18. An example of a protocol suitable for such a task is the diverse firmware upgrade universal serial bus (DFU USB) protocol.

It should be understood that the foregoing description is only illustrative of the invention. Various alternatives and modifications can be devised by those killed in the art without departing from the invention. Accordingly, the present invention is intended to embrace all such alternatives, modifications and variances which fall within the scope of the appended claims.

What is claimed is:

1. A method comprising:
storing at least one data element in an external memory located outside of a security boundary of an electronic device; and
executing a validation algorithm within said security boundary to repeatedly validate said at least one data element.

2. The method of claim 1 wherein said storing comprises storing said at least one data element in at least one of an external random access memory (RAM) and an external flash memory.

3. The method of claim 1 wherein executing said validation algorithm comprises:
validating a size of said at least one data element;
validating a hash of said at least one data element; and
validating a signature of a hash file comprising information corresponding to said at least one data element.

4. The method of claim 3 wherein said validating said size comprises:
retrieving a first size of said at least one data element from an operating system;
retrieving a second size of said at least one data element from said hash file; and
validating said size of said at least one data element if said first size is equivalent to said second size.

5. The method of claim 4 wherein said validating said hash of said at least one data element comprises:
retrieving a portion of said external memory corresponding to said at least one data element said portion of a size equal to said second size;
computing a first hash of said at least one data element from said portion of said external memory;
retrieving a second hash of said at least one data element from said hash file; and
validating said hash of said at least one data element if said first hash is equivalent to said second hash.

6. The method of claim 3 wherein validating said signature of said at least one data element comprises:
retrieving a signature from said hash file; and
validating said signature.

7. The method of claim 6 comprising utilizing a key stored in an internal memory located inside of said security boundary.

8. The method of claim 7 comprising storing said key in an internal flash memory.

9. The method of claim 1 comprising storing said validation algorithm in an internal memory located inside of said security boundary.

10. The method of claim 9 comprising storing said validation algorithm in an internal flash memory.

11. The method of claim 1 wherein executing said validation algorithm comprises executing said validation algorithm as a long running executable.

12. The method of claim 11 comprising executing said validation algorithm with a low priority.

13. The method of claim 1 comprising executing said validation algorithm at a power up.

14. The method of claim 1 wherein executing said validation algorithm comprises executing said validation algorithm with a priority sufficient to ensure execution of said alorithm.

15. The method of claim 1 comprising transmitting a result of said validation to a processor located outside of said security boundary.

16. The method of claim 15 comprising applying a signature to said result.

17. The method of claim 1 comprising executing said validation algorithm as part of an operation of a postal security device (PSD).

18. An apparatus comprising:
a processor coupled to an internal memory said processor and said internal memory residing within a security boundary;
at least one data element stored on an external memory residing outside said security boundary of an electronic device and accessible to said processor; and
a validation algorithm at least partially stored in said internal memory for execution by said processor to repeatedly validate said at least one data element.

19. The apparatus of claim 18 wherein said validation algorithm comprises a long running executable.

20. The method of claim 19 wherein said long running executable comprises a low priority.

21. The apparatus of claim 18 wherein said internal memory comprises at least one of an internal flash memory and an internal random access memory (RAM).

22. The apparatus of claim 18 wherein said external memory comprises at least one of an internal flash memory and an internal random access memory (RAM).

23. The apparatus of claim 18 comprising a hash file accessible to said processor comprising an identifier of said at least one data element, a size of said at least one data element, and a hash of said at least one data element for use in validating said at least one data element.

24. The apparatus of claim 23 wherein said hash file is stored in said internal memory.

25. The apparatus of claim 18 comprising a look-up table comprising a location of said at least one data element.

26. The apparatus of claim 25 wherein said look-up table is stored in an internal flash memory.

27. The apparatus of claim 18 wherein said apparatus comprises a postage security device (PSD).

28. A postage security device (PSD) comprising:
a processor coupled to an internal memory said processor and said internal memory residing within a security boundary;
at least one data element stored on an external memory residing outside said security boundary of an electronic device and accessible to said processor; and
a validation algorithm at least partially stored in said internal memory for execution by said processor to repeatedly validate said at least one data element.

29. The PSD of claim 28 wherein said validation algorithm comprises a long running executable.

30. The PSD of claim 29 wherein said long running executable comprises a low priority.

31. The PSD of claim 28 wherein said internal memory comprises at least one of an internal flash memory and an internal random access memory (RAM).

32. The PSD of claim 28 wherein said external memory comprises at least one of an internal flash memory and an internal random access memory (RAM).

33. The PSD of claim 28 comprising a hash file accessible to said processor comprising an identifier of said at least one data element, a size of said at least one data element, and a hash of said at least one data element for use in validating said at least one data element.

34. The apparatus of claim 33 wherein said hash file is stored in said internal memory.

35. The apparatus of claim 28 comprising a look-up table comprising a location of said at least one data element.

36. The apparatus of claim 35 wherein said look-up table is stored in an internal flash memory.
